(19) United States
(12) Patent Application Publication
(10) Pub. No.: US 2024/0191058 A1
(43) Pub. Date: Jun. 13, 2024

(54) CELLULOSE ESTER COMPOSITION AND MOLDED ARTICLE

(71) Applicant: Daicel Miraizu Ltd., Tokyo (JP)

(72) Inventors: Takayuki OGIHARA, Tokyo (JP); Kenji UEDA, Tokyo (JP); Akihiko KUMAGAE, Tokyo (JP)

(73) Assignee: Daicel Miraizu Ltd., Tokyo (JP)

(21) Appl. No.: 18/285,075

(22) PCT Filed: Apr. 4, 2022
(86) PCT No.: PCT/JP2022/017036

§ 371 Date: Sep. 29, 2023

(30) Foreign Application Priority Data
Apr. 7, 2021 (JP) 2021-065352

(51) Int. Cl. C08K 5/11; C08L 1/12; C08L 1/14; G02C 5/00

(52) U.S. Cl. CPC C08K 5/11; C08L 1/12; C08L 1/14; G02C 5/008; C08K 2201/014

(57) ABSTRACT

To provide a cellulose ester composition having good fluidity and being capable of providing a molded article that can suppress occurrence of a water spot. A cellulose ester composition containing: (A) 100 parts by mass of a cellulose ester, (B) from 19 to 45 parts by mass of a citrate-based compound having a solubility in water of 2 g/100 mL or less, and (C) from 1 to 9 parts by mass of an adipate-based compound.

### TECHNICAL FIELD

The present disclosure relates to a cellulose ester composition and a molded article obtained from the composition.

### BACKGROUND ART

Cellulose esters such as cellulose acetate generally exhibit poor thermoplasticity, and therefore are commonly used as compositions containing a plasticizer.

JP 5798640 B describes that from 1 to 50 parts by mass of an adipate represented by Formulas (I) to (III) can be blended with respect to 100 parts by mass of a cellulose ester.

JP 6038639 B describes a cellulose ester composition containing, with respect to 100 parts by mass of (A) a cellulose ester, from 5 to 50 parts by mass of (B) air adipate-based compound, and from 1 to 50 parts by mass of (C) a phosphate having a cresyl group and represented by General Formula (I), and bleed-out of the plasticizer is suppressed.

JP 6170654 B describes a cellulose ester composition containing, with respect to 100 parts by mass of (A) a cellulose ester, from 5 to 50 parts by mass of (B) a phosphate having a naphthyl group and represented by General Formula (I), from 5 to 40 parts by mass of (D) an ester-based plasticizer other than the aforementioned (B), and also describes that a resin molded body having high thermoplasticity and good mechanical strength can be obtained.

### SUMMARY OF INVENTION

An object of the present disclosure is to provide a cellulose ester composition having good fluidity, and a molded article that is obtained from the cellulose ester composition and that can suppress occurrence of a water spot.

The present disclosure provides a cellulose ester composition containing: (A) 100 parts by mass of a cellulose ester, (B) from 19 to 45 parts by mass of a citrate-based compound haying a solubility in water of 2 g/100 mL or less, and (C) from 1 to 9 parts by mass of an adipate-based compound.

The cellulose ester composition of the present disclosure has good fluidity, and a molded article obtained from the composition has good flexural modulus, and occurrence of a water spot is suppressed even when a water drop is attached.

### DESCRIPTION OF EMBODIMENTS

### Composition

### Component (A)

The cellulose ester of the component (A) is a known cellulose ester (for example, a cellulose ester described in JP 2005-194302 A), and examples thereof include cellulose acetate, cellulose propionate, cellulose butyrate, cellulose acetate propionate, and cellulose acetate butyrate.

Additionally, examples of the cellulose ester of the component (A) include polycaprolactone-grafted cellulose acetate, acetyl methyl cellulose, acetyl ethyl cellulose, acetyl propyl cellulose, acetyl hydroxyethyl cellulose, and acetyl hydroxypropyl cellulose.

Among these, cellulose acetate, cellulose acetate propionate, and cellulose acetate butyrate are preferred.

The cellulose ester of the component (A) is preferably a cellulose ester having an average degree of substitution of 2.7 or less. The cellulose ester of the component (A) is a cellulose ester having a viscosity-average degree of polymerization of preferably 100 to 1000, and more preferably from 100 to 500.

### Component (B)

The citrate-based compound having a solubility in water (25° C.) of 2 g/100 mL or less in the component (B) is a component that, when used together with the component (C), acts to enhance fluidity of the composition and particularly suppress occurrence of a water spot. The solubility in water of the component (B) is preferably 1.5 g/100 mL or less.

Examples of the component (B) include acetyl triethyl citrate, A commercially available product of the component (13) can be used, and for example, trade name “Citroflex A-2” (solubility in water: 0.72 g/100 mL (25° C.)) (available from Morimura Bros., Inc.) can be used.

### Component (C)

The adipate-based compound of the component (C) is a component that, when used together with the component (B), acts to enhance fluidity of the composition and particularly increase flexural modulus and impact strength.

The adipate-based compound of the component (C) contains at least one type selected from the group consisting of adipates represented by the following Formulas (I), (II), and (III) described in JP 5798640 B.

The component (C) may be any one selected from the group consisting of adipates represented by Formulas (I), (II), and (III), may be a mixture of any two, such as (I) and (II), (I) and (III), or (II) and (III), or may be a mixture of (I) to (III).

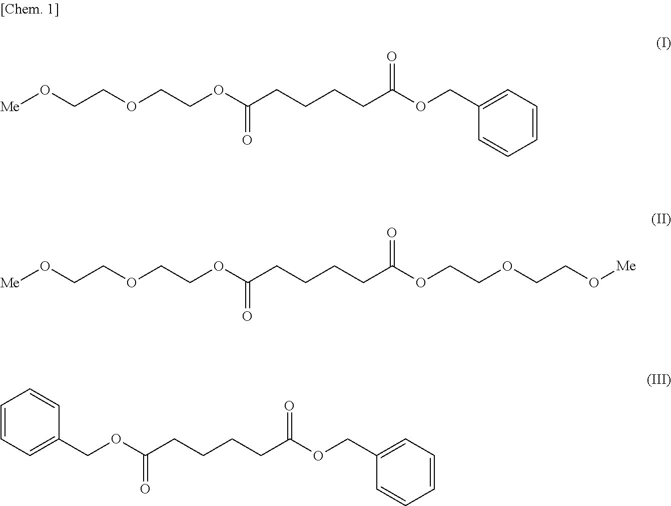 [SMILES: COCCOCCOC(=O)CCCCC(=O)OCc1ccccc1 ; COCCOCCOC(=O)CCCCC(=O)OCCOCCOC ; O=C(CCCCC(=O)OCc1ccccc1)OCc1ccccc1]

Regarding contents of the component (A), the component (B), and the component (C) in the composition of an embodiment of the present disclosure, with respect to 100 parts by mass of the component (A), the content of the component (B) is 19 to 45 parts by mass and preferably from 20 to 40 parts by mass, and the content of the component (C) is from 1 to 9 parts by mass and preferably from 1.5 to 9 parts by mass.

The total content of the component (B) and the component (C) in the composition of an embodiment of the present disclosure is preferably from 20 to 45 parts by mass, and more preferably from 25 to 40 parts by mass, with respect to 100 parts by mass of the component (A).

Regarding the respective contents of the component (B) and the component (C), to suppress the occurrence of a water spot, the content of the component (B) is preferably from 79 to 95 mass %, and more preferably from 79 to 93 mass %, and the content of the component (C) is preferably from 21 to 5 mass %, and more preferably from 21 to 7 mass %, with respect to 100 mass % of a total of the component (B) and the component (C).

The composition of an embodiment of the present disclosure can contain a known thermoplastic resin according to the application. Examples of known thermoplastic resins include styrene-based resins such as ABS resin and AS resin, polycarbonate-based resins, polyolefin-based resins such as polyethylene and polypropylene, polyamide-based resins such as polyamide 6, polyamide 66, polyamide 610, and polyamide 612, acrylic resins, methacrylic resins, polyester resins, polyacetal resins, and polyphenylene sulfide resins.

A content of the known thermoplastic resin is preferably 40 mass % or less, and more preferably 20 mass % or less, in a total amount of the thermoplastic resin and the cellulose ester of the component (A).

The composition of an embodiment of the present disclosure can further contain a filler. The filler includes a fibrous filler and non-fibrous filler (such as a granular or tabular filler), and examples thereof may include the filler described in paragraphs [0025] to [0032] of JP 2005-194302 A.

A content of the filler is preferably from 5 to 50 parts by mass, more preferably from 5 to 40 parts by mass, and even more preferably from 5 to 30 parts by mass, with respect to 100 parts by mass of the cellulose ester of the component (A).

The composition of an embodiment of the present disclosure can contain a stabilizer such as an epoxy compound described in paragraphs [0035] to [0042] of JP 2005-194302 A, or an organic acid, a thioether, or a phosphite compound as described in paragraphs [0043] to [0052] thereof.

The composition of an embodiment of the present disclosure may contain, depending on the application, a commonly used additive such as another stabilizer (e.g., an antioxidant, UV absorber, thermal stabilizer, and light-resistant stabilizer), a colorant (such as a dye or pigment), an antistatic agent, a flame retardant, a flame retardant auxiliary agent, a lubricant, an anti-blocking agent, a dispersant, an anti-dripping agent, and an antibacterial agent.

The composition of an embodiment of the present disclosure preferably has an MI (g/10 min) of 20 g/10 min or greater, and more preferably from 20 to 70 g/10 min.

The composition of an embodiment of the present disclosure may be prepared by, for example, mixing the components in a dry or wet state using a mixer such as a tumbler mixer, a Henschel mixer, a ribbon mixer, or a kneader.

After the components are pre-mixed using the mixer, a method of kneading the mixture using an extruder such as a single-screw or twin-screw extruder to prepare the composition in the form of pellets, or a method of melting and kneading the mixture using a kneader such as a heated roller or a Banbury mixer to prepare the composition can be used.

### Molded Article

The composition of an embodiment of the present disclosure can be molded into various molded articles by injection molding, extrusion molding, multilayer extrusion molding, press molding, vacuum molding, profile molding, foaming molding, injection press molding, blow molding, and gas injection molding.

The molded article of an embodiment of the present disclosure has a flexural modulus (MPa) (ISO 178) of preferably 1800 MPa or greater, and more preferably 2000 MPa or greater.

The composition of an embodiment of the present disclosure can be used, for example, to manufacture molded articles having a pattern (design) or no pattern, such as frames for sunglasses and eyeglasses, shoelace tipping films (used by surrounding the tip end part of a shoelace with the film and heat-shrinking the film) for various types of shoes, and goggles; cosmetic containers; oral care products such as handles of toothbrushes and interdental brushes; makeup articles such as handles of cheek brushes, eyebrow brushes, and lip brushes; hair care articles such as hair accessories, hair dryers, hair irons, hair brushes, and combs; writing instruments such as the shaft of ink pens; personal care items such as razor handles; toys; and household appliances and tools.

Among these, an eyeglass frame in which the composition of an embodiment of the present disclosure is used exhibits excellent processability, tactile sensation, color sensation, and impact resistance.

Each of the molded articles described above can be manufactured using an injection molding method or the like, and, additionally, a molded article such as a frame for sunglasses or eyeglasses can be manufactured by punching a single sheet or a laminated product of a plurality of sheets.

The sheet for manufacturing an eyeglass frame can be manufactured by extruding the composition from a T-die of an extruder to form a sheet, cutting the sheet, and then repeatedly press molding.

Each aspect disclosed in the present specification can be combined with any other feature disclosed herein. Note that the configurations, combinations thereof, and the like in each embodiment of the present disclosure are examples, and various configurational additions, omissions, substitutions, and other changes may be made, as appropriate, without departing from the spirit of the disclosure of the present invention. The present disclosure is not limited by the embodiment and is limited only by the claims.

### EXAMPLES

Each of the compositions shown in Table 1 was prepared by stirring and mixing the cellulose ester of the component (A), the citrate-based compound of the component (B), and the adipate-based compound of the component (C) using a Henschel mixer such that the inside of the mixer reached 70° C. or higher due to frictional heat, after which each composition was supplied to a twin-screw extruder (cylinder temperature: 200° C., die temperature: 210° C.) and extruded and pelletized.

The obtained pellets were supplied to an injection molding machine, and a test piece was injection-molded under conditions including a cylinder temperature of 220° C., a mold temperature of 50° C., and a molding cycle of 60 seconds (injection: 20 seconds, cooling time: 40 seconds). The test pieces were used in each evaluation test listed in Table 1.

### Components Used

### Component (A)

Cellulose ester: trade name “L50”, degree of substitution of 2.5, viscosity-average degree of polymerization of 180, available from Daicel Corporation

### Component (B)

Citrate-based compound (including acetyl triethyl citrate): trade name “Citroflex A-2” (solubility in water: 0.72 g/100 mL (25° C.)), available from Morimura Bros., Inc.

### Component (C)

Adipate-based compound (mixture of Formulas (I) to (III) above): trade name “DF101”, available from Daihachi Chemical Industry Co., Ltd.

### Flexural Modulus (MPa)

Measured in accordance with ISO 178.

### Charpy Impact Strength (kJ/m²)

Notched Charpy impact strength was measured in accordance with ISO 179/1eA.

### MI (g/10 min)

The measurement was performed at a temperature of 220° C. and a load of 10 kg.

### Water Spot

In a laboratory at 23° C. and 50RH, two drops (0.1 to 0.4 mL) of pure water were dropped on a 50 mm×90 mm×3 mmt transparent plate by using a transfer pipette, and water spots remained on the transparent plate were visually observed after 5 hours and evaluated as follows.
O: No water spots were visually observed.
Δ: When the angle of sun light to the transparent plate was varied, water spots were slightly observed.
×: Water spots were visually clearly observed.

TABLE 1

| | Examples | | | | | | | |
|---|---|---|---|---|---|---|---|---|
| | 1 | 2 | 3 | 4 | 5 | 6 | 7 | 8 |
| (A) Cellulose acetate | 100 | 100 | 100 | 100 | 100 | 100 | 100 | 100 |
| (B) Citroflex AII | 28.5 | 32 | 31.5 | 35.5 | 34 | 29 | 32.5 | 24 |
| (C) DF101 | 7 | 3.5 | 8 | 4 | 5.5 | 6.5 | 7.5 | 6 |
| (B) + (C) | 35.5 | 35.5 | 39.5 | 39.5 | 39.5 | 35.5 | 40 | 30 |
| (B) × 100/[(B) + (C)] | 80.3 | 90 | 79.7 | 89.9 | 86.1 | 81.7 | 81.3 | 80 |
| (mass %) | | | | | | | | |
| MI (g/10 min) | 36 | 38 | 62 | 53 | 63 | 48 | 66 | 28 |
| Flexural modulus (MPa) | 2300 | 2300 | 2010 | 2010 | 2080 | 2270 | 1990 | 2700 |
| Charpy impact strength | 7.5 | 6.9 | 7.7 | 7 | 6.9 | 7.2 | 7 | 6.3 |
| (kJ/m²) | | | | | | | | |
| Water spot | ∘ | ∘ | ∘ | ∘ | ∘ | ∘ | ∘ | ∘ |
| | Examples | | | Comparative Examples | | | | |
| | 9 | 10 | 11 | 1 | 2 | 3 | 4 | 5 |
| (A) Cellulose acetate | 100 | 100 | 100 | 100 | 100 | 100 | 100 | 100 |
| (B) Citroflex AII | 22 | 29 | 32 | 25 | | 18 | 40 | 30 |
| (C) DF101 | 5 | 3 | 4.5 | | 25 | 5 | | 10 |
| (B) + (C) | 27 | 32 | 36.5 | 25 | 25 | 23 | 40 | 40 |
| (B) × 100/[(B) + (C)] | 81.5 | 90.1 | 87.8 | — | — | 78.3 | — | 75 |
| (mass %) | | | | | | | | |
| MI (g/10 min) | 22 | 23 | 43 | 10 | 34 | 15 | 50 | 64 |
| Flexural modulus (MPa) | 2900 | 2800 | 2360 | 3150 | 2700 | 3200 | 2200 | 1880 |
| Charpy impact strength | 6.1 | 6.5 | 6.7 | 4.7 | 7.4 | 4.8 | 4.8 | 5.2 |
| (kJ/m²) | | | | | | | | |
| Water spot | Δ | ∘ | ∘ | ∘ | x | x | ∘ | x |

As is clear from Table 1, since Examples 1 to 11 used a combination of the component (B) and the component (C), well-balanced results were achieved for the four measurement items.

Comparative Example 2, in which no component (B) was contained, and Comparative Examples 3 and 5, in which the content of the component (B) was relatively small although the components (B) and (C) were contained, could not suppress the occurrence of water spots.

In particular, from the comparison between Example 3 ((B)×100/[(B)+(C)])=79.7 mass %) and Comparative Example 3 ((B)×100/[(B)+(C)])=78.3 mass %), it was confirmed that the suppression effect of water spots can be enhanced by adjusting the content of the component (B) to a predetermined range with respect to the total amount of the component (B) and the component (C).

Comparative Example 1, in which no component (C) was contained, was capable of suppressing occurrence of water spots; however, the fluidity and the impact strength were not good. Comparative Example 4, in which no component (C) was contained, was capable of suppressing occurrence of water spots; however, the flexural modulus and the impact strength were not good.

### Industrial Applicability

The cellulose ester composition of an embodiment of the present disclosure can be used as a manufacturing raw material for a frame for sunglasses, eyeglasses, and the like.

1. A cellulose ester composition comprising:
(A) 100 parts by mass of a cellulose ester,
(B) from 19 to 45 parts by mass of a citrate-based compound having a solubility in water of 2 g/100 mL or less, and
(C) from 1 to 9 parts by mass of an adipate-based compound.

2. The cellulose ester composition according to claim 1, wherein the citrate-based compound of the component (B) is acetyl triethyl citrate.

3. The cellulose ester composition according to claim 1, wherein the adipate-based compound of the component (B) contains at least one type selected from the group consisting of adipates represented by Formulas (I), (II), and (III):

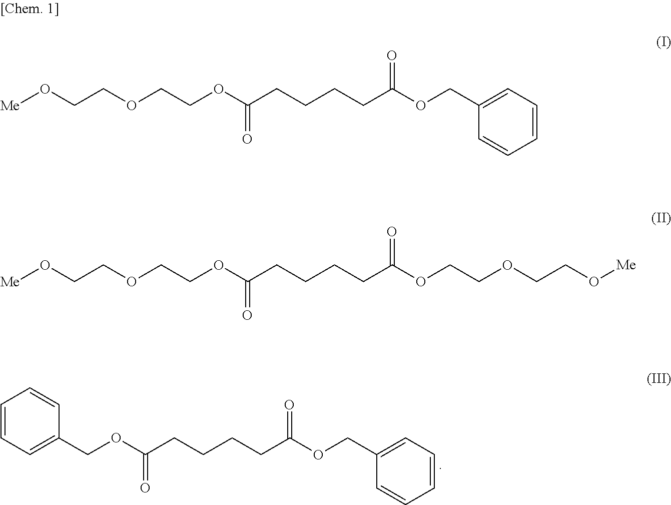 [SMILES: COCCOCCOC(=O)CCCCC(=O)OCc1ccccc1 ; COCCOCCOC(=O)CCCCC(=O)OCCOCCOC ; O=C(CCCCC(=O)OCc1ccccc1)OCc1ccccc1]

4. The cellulose ester composition according to claim 1, wherein a total content of the component (B) and the component (C) is from 20 to 45 parts by mass with respect to 100 parts by mass of the component (A).

5. The cellulose ester composition according to claim 1, wherein a content of the component (B) is from 79 to 95 mass % and a content proportion of the component (C) is from 21 to 5 mass % with respect to 100 mass % of a total of the component (B) and the component (C).

6. The cellulose ester composition according to claim 1, wherein the cellulose ester of the component (A) is selected from the group consisting of cellulose acetate, cellulose acetate propionate, and cellulose acetate butyrate.

7. A molded article comprising the cellulose ester composition described claim 1.

8. The molded article according to claim 7, wherein the molded article is an eyeglass frame.
